(19) United States
(12) Patent Application Publication
(10) Pub. No.: US 2013/0104174 A1
(43) Pub. Date: Apr. 25, 2013

(54) VIDEO TRANSMITTING AND RECEIVING METHOD BETWEEN DOCKED TERMINALS AND DOCKING SYSTEM USING THE SAME

(71) Applicants: Byeong-Nam AHN, Seong nam (KR); Syeung-il KIM, Seong nam (KR); Young-Mook CHO, Seong nam (KR)

(72) Inventors: Byeong-Nam AHN, Seong nam (KR); Syeung-il KIM, Seong nam (KR); Young-Mook CHO, Seong nam (KR)

(73) Assignee: HANDONG LNC CO., LTD., Seongnam-si (KR)

(21) Appl. No.: 13/281,400

(22) Filed: Oct. 25, 2011

(51) Int. Cl. H04N 7/18

(52) U.S. Cl. 725/80

(57) ABSTRACT

A video transmitting and receiving method between docked terminals and docking system using the same are disclosed. The video transmitting and receiving method between docked terminals includes determining whether or not the first terminal is connected to the second terminal through an HDMI interface, receiving by the first terminal information on the second terminal, when it is determined that the first terminal is connected to the second terminal through the HDMI interface, providing by the first terminal video to the second terminal, based on information on the second terminal, and activating by the second terminal devices related to displaying of the video, when it is determined that the video is received from the first terminal. This method grants maximum authority regarding the HDMI interface itself, minimizing operational delay and error.

### BACKGROUND OF THE INVENTION

1. Field of the Invention

Methods and apparatuses consistent with the exemplary embodiments relate to a video transmitting and receiving method between docked terminals and docking system using the same, and more particularly, to a video transmitting and receiving method between docked terminals for enabling video provided from one of the docked terminals to be displayed on another docked terminal, and a docking system using the same.

2. Description of the Prior Art

Due to the recent remarkable development of communications technology and popularization of smart phones, a lot of people have smart phones nowadays not merely for telephoning purposes but also for various purposes such as entertainment, writing documents, trading stocks, playing multimedia, and maintaining social relationships etc.

However, a smart phone is equipped with a limited interface device, unlike those used in computers such as mass storage devices, backup devices, and local printers. Moreover, since smart phones are designed with priority consideration given to portability, it is true that the size of display is limited and that the size of buttons and items on a screen is small, making it difficult for a user to manipulate the device quickly and easily.

Therefore, in reality most of the smart phone users perform necessary operations or work through a separate device such as a desktop, notebook, and laptop when they are at home, and use their smart phones only in situations where they cannot use a separate device.

However, if a user is to use an application or environment that he/she used in a smart phone in a separate device once again, there is inconvenience of having to transfer the data stored in the smart phone to the separate device.

In order to increase convenience when using a smart phone which has limited interface device, a docking station for providing an additional input/output interface device is used. When using the docking station, the user is able to use an extension slot, external memory device, dialogue surface display, keyboard, mouse, and local printer, which increases efficiency of operations or work. Furthermore, since the user could use the application and environment that he/she used in the smart phone, the operations or work can be continued.

However, in the case of docking two terminals and using them, it is difficult to show smooth, natural operations and signal processing as if the docked two terminals were released as one terminal.

For example, in the case of interlocking a smart phone to a dummy terminal having a large display in order to overcome the disadvantage of the smart phone, which is the small display, there is a big difference between displaying the result processed in the smart phone on the screen of the smart phone itself and enabling the result processed in the smart phone to be displayed on the screen of the dummy terminal. Especially in this case, communication process between the two terminals will be added, causing delays etc., and thus users of the docking system will experience confusion regarding the state of the docking system and will have difficulties in manipulating the docking system.

In addition, even though technologies which take into account such delays in interlocking terminals are being developed, since existing technologies generally receive video signals after activating all devices related to displaying in the dummy terminal, there comes a state where the devices are activated but video signals are not received yet, that is, the point from where the devices are activated until where video signals are received. This state may not be that long in terms of time, but it may cause a situation where nothing is on the screen when a touch screen module and backlight module are operable, causing confusion and inconvenience to users using docking systems.

Therefore, there is a need to seek a way to minimize delay caused by communication between terminals, and furthermore, to achieve activation of display devices and synchronization of video display.

### SUMMARY OF THE INVENTION

The purpose of the present disclosure is to provide a way for minimizing delay caused by communication between docked terminals, for activating devices needed for displaying, and synchronizing displaying.

According to an exemplary embodiment of the present disclosure, a video transmitting and receiving method between docked terminals for enabling video provided from one of a first terminal and a second terminal to be displayed on the other terminal, in the case where the first terminal is docked on the second terminal through a plurality of interfaces may include determining whether or not the first terminal is connected to the second terminal through an HDMI interface; receiving by the first terminal information on the second terminal, when it is determined that the first terminal is connected to the second terminal through the HDMI interface; providing by the first terminal video to the second terminal, based on information on the second terminal; and activating by the second terminal devices related to displaying of the video, when it is determined that the video is received from the first terminal.

The activating by the second terminal may include transmitting, by the first terminal, information that video is being received from the first terminal, to a device driver of the second terminal; transmitting, by the device driver, information to an event controller which manages events occurring when connecting the first terminal and the second controller; transmitting, by the event controller, a command regarding activation of the devices to the device driver; and activating, by the device driver, the devices.

The providing by the first terminal video to the second terminal is characterized in that the video may be provided to the second terminal in a state where devices of the second terminal are inactivated, and thus may not be displayed on a screen of the second terminal.

The devices related to displaying of the video is may include a touchscreen panel, LCD and backlight.

The information on the second terminal may be EDID information of the second terminal and may include resolution, horizontal frequency, and vertical frequency information.

The determining whether or not the first terminal is connected to the second terminal may be characterized in that it is determined that the first terminal is connected to the second terminal when the first terminal transmits a signal through a +5V line of the HDMI interface and then receives the signal from the second terminal through an HPD line.

According to an exemplary embodiment of the present disclosure, a docking system for enabling video received from one of a first terminal and a second terminal to be displayed on the other terminal, in the case where the first terminal is docked on the second terminal through a plurality of interfaces may include a first terminal which determines whether or not it is connected to the second terminal through an HDMI interface, receives information on the second terminal, and when it is determined that it is connected to the second terminal through the HDMI interface provides video to a second terminal based on the information on the second terminal; and a second terminal which activates devices related to displaying of the video, when it is determined that video is received from the first terminal.

### BRIEF DESCRIPTION OF THE DRAWINGS

The above and/or other aspects of the present disclosure will be more apparent by describing certain present disclosure with reference to the accompanying drawings, in which:

FIGS. 1 and 2 are views illustrating a docking system where the present disclosure is applicable;

FIG. 3 is a block diagram of the aforementioned docking system;

FIG. 4 is a view partially illustrating an architecture layer under an android platform, as one of application systems which can be used in a smart phone and a smart pad;

FIG. 5 is a flowchart provided to explain a method for receiving video from the smart phone and displaying by the smart pad the received video;

FIG. 6 is a view provided to explain a signal flow according to an HDMI interface standard which is applied to the present disclosure;

FIG. 7 is a view provided to explain a device activation according to an exemplary embodiment of the present disclosure; and

FIG. 8 is a view illustrating processes from the state where a device is not activated until when it is activated, in time order.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

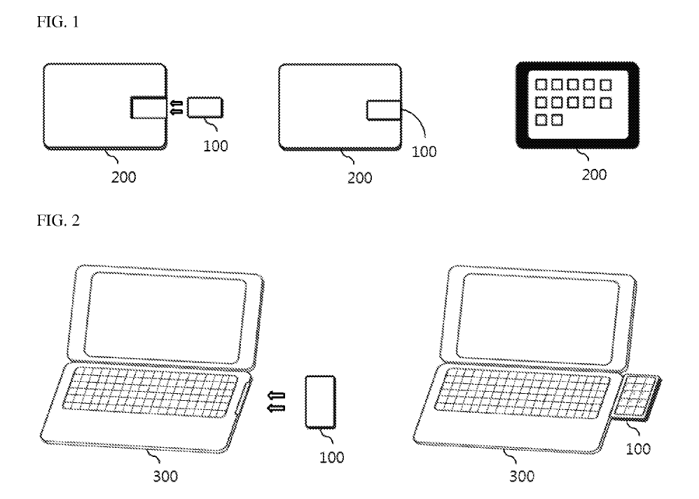

FIGS. 1 and 2 are views illustrating a docking system where the present invention is applicable.

First of all, FIG. 1 is a view illustrating the docking system for interlocking between a smart phone 100 and a smart pad 200. The smart phone 100 and the smart pad 200 may each be operated by separate operation systems, may drive separate application programs, and are equipped with separate devices. Of course, such operation systems and applications may be the same, similar, or different from each other, just as their provided devices may be the same, similar or different from each other.

For example, the smart phone 100 may be operated by an android operation system and drive application programs A, B, and C, while the smart pad 200 is operated by the same android operating system, but drive application programs B, C, and D. Similarly, the smart phone 100 may be equipped with a communications module for phone-calling and a camera module for photo-graphing, while the smart pad 200 is equipped with the same communications module for phone-calling, but also a camera module having higher specifications.

The present disclosure presents a way to resolve the delay problem and the sync problem which may occur in the case of using docked terminals having the same device but when the specifications of that same device is different from each other. Especially, the present disclosure provides a solution to the delay problem, sync problem, and even the user's confusion and the difficulty of manipulation, in the case where video processed or generated in the smart phone 100 is output in the smart phone's 200 display having higher specifications.

Since the smart phone 100 and the smart pad 200 are equipped with separate operating systems and thus operate according to separate operating systems, if they are not docked to each other as in the first illustration in FIG. 1, they are operated separately by their own operation systems.

However, in the smart phone 100 and the smart pad 200 according to the present disclosure, the smart phone 100 can be docked on a docking station located in a rear surface of the smart pad 200 as illustrated in the second illustration in FIG. 1. Of course, since the docking station is located in the rear surface of the smart pad 200, when using the smart pad 200 with the smart phone 100 docked on the smart pad 200, in order to prevent any input by error manipulation of the smart phone 100, the docking should be done in such a manner that a front surface of the smart phone 100 is not exposed, as in the second illustration in FIG. 1.

The third illustration in FIG. 1 is a screen which is operated by the operating system in the smart phone 100, or operated by the application program installed in the smart phone 100, after the smart phone 100 and the smart pad 200 are docked to each other.

As mentioned above, in the case of docking the smart phone 100 and the smart pad 200 and thereby interlocking the usage of the two terminals, a user is able to continue any operation or work that he/she used to do in the smart phone 100. Not only that, the user is able to use devices such as a display or a high-power speaker of the smart pad 200, which is an advantage of the smart pad 200, improving convenience of the user's operations or work.

Next, FIG. 2 illustrates a docking system for interlocking usage between the smart phone 100 and a laptop 300. The main difference of FIG. 1 from FIG. 2 is that in the docking system of FIG. 2, the smart phone 100 is not docked to be completely inserted into the docking system but is inserted partially into the docking station, enabling the smart phone 100 to function as a number pad for the laptop 300.

Therefore, unlike in FIG. 1, the smart phone 100 is docked on the laptop 300 in such a manner that a display of the smart phone 100 is exposed.

Also by the aforementioned method, in the case of docking the smart phone 100 and the laptop 300 and thereby interlocking the usage of the two terminals, the user becomes able to continue any operation or work that he/she used to do in the smart phone 100 in the laptop 300. Not only that, the user can make use of the advantages of the laptop 300 as well.

Meanwhile, although in FIG. 2 the smart phone 100 is used as the number pad for the laptop 300, this is only an example for the convenience of explaining the present disclosure, and thus the technical concept of the present disclosure can also be applied when the smart phone 100 is used as a general touch pad instead of the number pad.

In addition, although in FIGS. 1 and 2, the smart phone 100 is docked on the smart pad 200 and the laptop 300, respectively, this is also only examples for convenience of explaining the present disclosure, and thus so long as separate terminals are docked to each other, such as the smart pad 200 and the laptop 300 being docked to each other or the smart phone 100 and a desktop (not illustrated) being docked to each other, these are all regarded to be within the scope of applying the present disclosure.

Furthermore, the docking locations or methods of the aforementioned smart phone 100 are also mere examples for the convenience of explaining the present disclosure, and thus the present disclosure could also be applied to cases of dockings by other methods and in locations not illustrated herein.

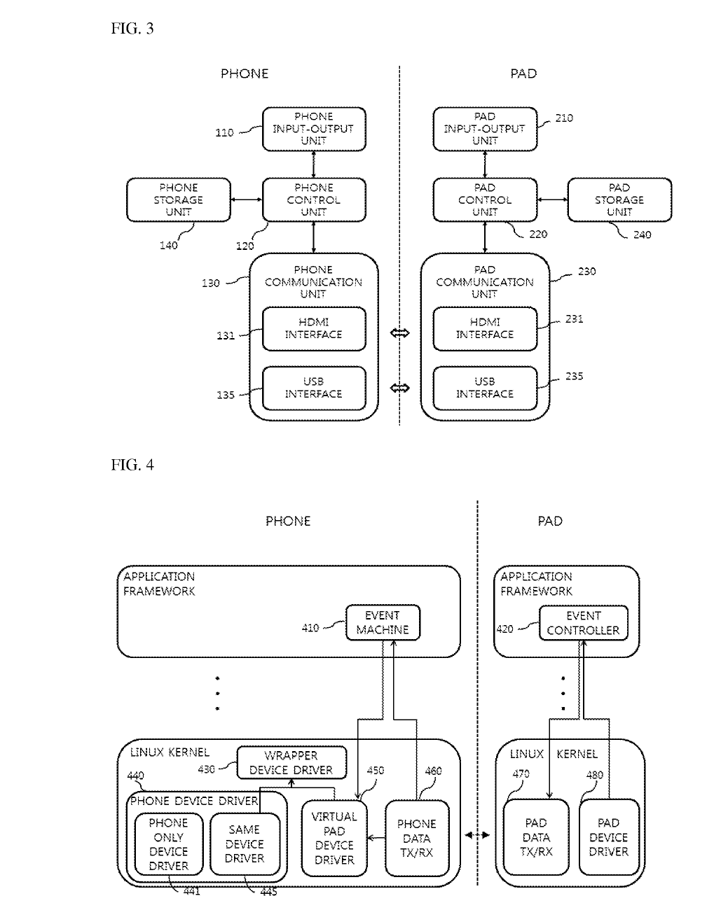

FIG. 3 is a block diagram of the aforementioned docking system. Hereinafter for convenience of explaining the present disclosure, the supposition will be that the smart phone 100 and the smart pad 200 are docked and interlocked to each other.

The smart phone 100 comprises a phone input-output unit 110, a phone control unit 120, a phone communication unit 130 and a phone storage unit 140.

The phone input-output unit 110 is used for the purpose of receiving signals input from a user or an external server or a terminal such as a touch screen, a button, and a speaker, and displaying the received signals on a screen or outputting them as voice.

The phone control unit 120 controls the phone input-output unit 110, the phone communication unit 130, and the storage unit 140 in such manners that the smart phone 100 can perform its functions properly. Especially, the phone control unit 120 controls the phone input-output unit 110 to process signals or user inputs received, and to display or output the processed results through the phone input-output unit 110. In addition, the phone control unit 120 controls the phone communication unit 130 to enable information exchange and data transmission and reception between the smart phone 100 and the smart pad 200. Not only that, the phone control unit 120 controls the phone storage unit 140 to store data transmitted to the phone input-output unit 100 and data transmitted and received through the phone communication unit 130, or to display data stored in the phone storage unit 140 through the phone input-output unit 110 or to transmit data to the smart pad 200.

Furthermore, the phone control unit 120 controls so that the smart phone 100 is implemented according to an operating system or an application program stored in the phone storage unit 140.

In addition, the phone control unit 120 controls each device of the smart pad 200 to operate according to the operating system or the application program implemented in the smart phone 100, in the case where the smart phone 100 is docked on the smart pad 200.

For example, in the case where the smart phone 100 is docked on the smart pad 200, the phone control unit 120 controls the phone input-output unit 110 to be inactivated, that the input-output data is transmitted to the smart pad 200 through the phone communication unit 140 and is input-output in the smart pad 200.

Under the control of the phone control unit 120, the phone communication unit 130 operates as a means to communicate with the smart pad 200 or an external terminal. Especially, the phone communication unit 130 is equipped with an HDMI interface 131 and a USB interface 135, so as to transmit/receive data and signals by communicating with the smart pad 200.

Meanwhile, the HDMI interface 131 of the phone communication unit 130 is equipped with an additional transmission/reception chip for signal transmission/reception besides a chip provided in the phone control unit 120, and thus is able to transmit/receive signals according to commands generated in itself.

The phone storage unit 150 stores operating systems or application programs for driving the smart phone 100.

As aforementioned, through the HDMI interface 131 and USB interface 135 provided in the phone communication unit 130, the smart phone 100 enables screens or voices generated in the smart phone 100 to be displayed or output in the smart pad 200.

Meanwhile, the smart pad 200 comprises a pad input-output unit 210, a pad control unit 220, a pad communication unit 230, and a pad storage unit 240.

Hereinafter the explanation will be focusing on the operations in the case where the smart phone 100 is docked on the smart pad 200.

The pad control unit 220 controls the pad communication unit 230 to enable information exchange and data transmitting/receiving between the smart phone 100 and the smart pad 200. Not only that, the pad control unit 220 controls the pad storage unit 240 to store data received from the smart phone 100 through the pad communication unit 240 or to transmit data stored in the pad storage unit 240 to the smart phone 100.

In the case where the smart phone 100 is docked on the smart pad 200, the pad control unit 220 controls each device of the smart pad 200 to operate according to operating systems and application programs implemented in the smart phone 100.

Meanwhile, the HDMI interface 231 of the pad communication unit 230 is equipped with an additional transmission/reception chip for signal transmission/reception besides a chip provided in the pad control unit 220, and thus is able to transmit/receive signals or transmit the transmitted/received signal according to commands generated in itself.

Especially, the HDMI interface 231 of the pad communication unit 230 is able to receive video which is to be displayed on the smart pad 200 with only the signal transmission/reception with the HDMI interface 131 of the phone communication unit 130, without any communication between the HDMI interface 231 and the pad control unit 220. Not only that, the HDMI interface 231 of the pad communication unit 230 becomes able to transmit each signal to the device driver where the signal received from the HDMI interface 131 of the phone communication unit 130 should be processed, without any communication between the HDMI interface 231 and the pad control unit 220.

As aforementioned, the present disclosure grants a maximum amount of authority to the HDMI interfaces 131, 231 provided in the phone communication unit 130 and the pad communication unit 230, minimizing the communication between each HDMI interface 131, 231 and the phone control unit 121 or the pad control unit 220. This prevents time delay and error which may be caused by communication between the HDMI interfaces 131, 231 and the phone control unit 120 or the pad control unit 220.

Meanwhile, when the smart pad 200 is not interlocked to the smart phone 100, the smart pad 200 is operated by its separate operating system, but when the smart pad 200 is interlocked to the smart phone 100, the smart pad 200 receives data regarding the operations by the operating system of the smart phone 100 from the smart phone 100 through the pad communication unit 230 and provides the data to the user.

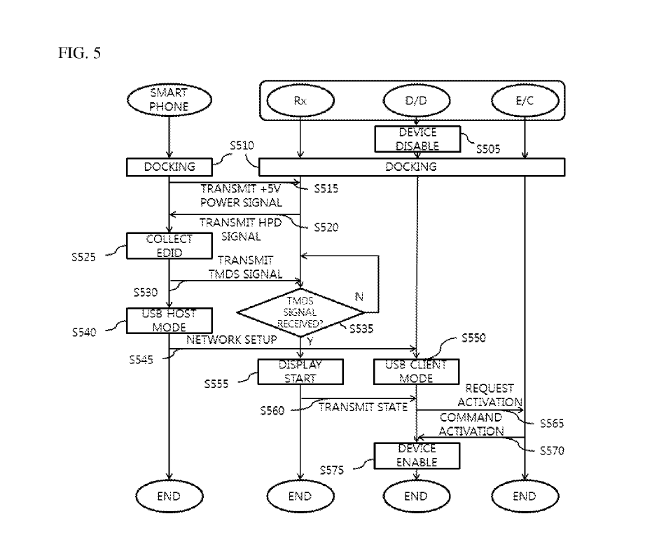

FIG. 4 partially illustrates an architecture layer under an android platform, which is one of the application systems that can be used in the smart phone 100 and the smart pad 200. The android operating system is stored in the phone storage unit 140 of the smart phone 100 and the pad storage unit 240 of the smart pad 200, enabling the smart phone 100 and the smart pad 200 to operate according to the android operating system stored in the smart phone 100 and the smart pad 200.

The android platform refers to a software package which includes a Linux Kernel, HAL (Hardware Abstraction Layer), Library, application framework, and application, and hereinafter, the explanation will focus on the application framework layer and the Linux Kernel layer which are necessary portions in understanding the present disclosure.

The application framework layer is a layer just below the uppermost layer, the application layer. In the application framework layer, there are various controllers in demon forms and the controllers manage the operating system. Especially in such an application framework, there is an event machine 410 or an event controller 420.

The event machine 410 which operates in the application framework layer of the smart phone 100 manages a wrapper device driver 430 which will be explained in detail hereinafter and performs the role of managing the events that occur in the smart phone 100 when the smart phone 100 and the smart pad 200 are connected to each other.

In addition, the event controller 420 which operates in the application framework layer of the smart pad 200 performs the role of managing the events that occur in the smart pad 200 when the smart phone 100 and the smart pad 200 are connected to each other.

The lowermost layer is the Linux Kernel layer. Various drivers such as a display driver, a camera driver, and an audio driver are included in the Linux Kernel layer, and the Linux Kernel takes the role of an abstraction layer among the remaining layers of the hardware and the android platform stack.

Meanwhile, the Linux Kernel layer of the smart phone 100 includes a Phone Only Device Driver 441 which is a driver for the devices that exist only in the smart phone 100, and a same device driver 445 which is a driver for the devices that exist both in the smart phone 100 and the smart pad 200.

In addition, in the case where the smart phone 100 already knows a device list of the smart pad 200, the smart phone 100 generates a Virtual Pad Device Driver 450 regarding those devices, and the wrapper device driver 430 manages the interlocked operations of the smart phone 100 by supervising the same device driver 445 and the Virtual Pad Device Driver 450 together.

Meanwhile, data transmission/reception between the smart phone 100 and the smart pad 200 is made through a phone data TX/RX 460 and a PAD data TX/RX 470, which are the same concepts of the aforementioned phone communication unit 130 and the pad communication unit 230, respectively.

Hereinabove, the supposition was that the event machine 410 and the event controller 420 exist in the application framework layer, but that was merely for the convenience of explaining the present disclosure. Thus, the technical concept of the present disclosure would also apply to the cases where the event machine 410 and the event controller 420 exist in other layers of the upper layers of the Kernel layer not only in the framework layer. The present disclosure would also apply to the case where the event machine 410 and the event controller 420 exist in the Kernel layer as well.

Not only that, the aforementioned explanation on the layer of the event machine 410 and the event controller 420 is based on the assumption that the smart phone 100 or the smart pad 200 uses OS such as Linux Kernel, and thus if the smart phone 100 or the smart pad 200 operates on the basis of NON-OS such as by using a firmware, the event machine 410 and the event controller 420 would exist as one code within the firmware.

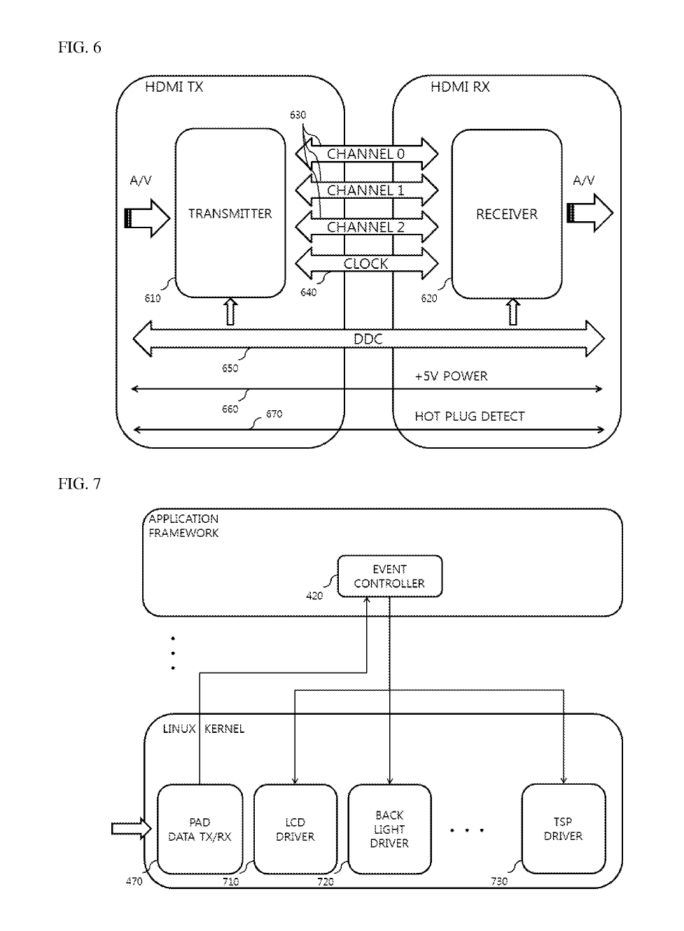

Referring to FIGS. 5 to 8 hereinbelow is explanation on a method for enabling video provided from the smart phone 100 to the smart pad 200 to be displayed on a screen of the smart pad 200.

FIG. 5 is a flowchart provided to explain a method for receiving video from the smart phone 100 and enabling the smart pad 200 to display the received video.

The explanation will be based on the supposition that the smart pad 200 consists of an HDMI interface 231, a device driver and an event controller 420, as aforementioned, and for the sake of convenience in explaining, the HDMI interface 231, the device driver and the event controller 420 will be named RX, D/D and E/C respectively.

First of all, before the smart phone 100 and the smart pad 200 are docked on each other and the video generated or processed in the smart phone 100 is transmitted to the smart pad 200, the devices related to displaying the videos need to be inactivated by the D/D (S505).

Thereafter, when the smart phone 100 and the smart pad 200 are docked on each other (S510), and thus the HDMI interface 131 and the USB interface 135 of the smart phone 100 are physically connected to the HDMI interface 231 and the USB interface 235 of the smart pad 200, the smart phone 100 transmits +5V POWER signal to the RX through +5V POWER line of the HDMI interface 131 (S515). When the HDMI interfaces 131, 231 of the smart phone 100 and the smart pad 200 are physically connected to each other, the RX responds to the +5V POWER signal and transmits an HPD signal to the smart phone 100 (S520).

Besides the aforementioned +5V POWER signal and the HPD signal, hereinbelow the explanation will be made with reference to FIG. 6, for better understanding of EDID information and TMDS signal which will be presented later on.

FIG. 6 is a view provided to explain the flow of signals according to the HDMI interfaces 131, 231 standard applied to the present disclosure.

The HDMI interfaces 131, 231 may be divided into a TX which is a transmitting unit, or an RX which is a receiving unit, and the HDMI interface 131 of the smart phone 100 is TX while the HDMI interface of the smart pad 200 is RX.

The TX has a transmitter 610 which receives a video signal and an audio signal from outside and transmits the received video signal and the audio signal to a receiver 620 of the RX through TMDS channel 0, 1, 2 (630). In addition, the transmitter 610 transmits a clock signal for synchronization with the receiver 620 through the clock channel 640.

The RX has a receiver 620 which receives TMDS signals, the video signal and audio signal, through the TMDS channel 0, 1, 2 (630), and receives the clock signal for synchronization with the transmitter 610 through the clock channel 640.

In addition, the TX and RX are mutually connected through a DDC 650 (Display Data Channel) which is a standard defined by the international standards organization, VESA. The DDC 650 is a standard defined for transmitting information such as resolution, horizontal frequency or vertical frequency, and setting the environment of the receiving side, or reading the information of the receiving side, perceiving the information, and setting new information for the receiving side.

Not only that, the TX and RX are mutually connected through a +5V POWER line 660 and an HPD (Hot Plug Detect) line 670. As aforementioned, the +5V POWER line 660 and the HPD line 670 are lines used to notify that the HDMI interfaces 131, 231 are connected to each other physically, and when a response signal is transmitted through the HPD line 670 regarding the +5V POWER signal which is received through the +5V POWER line 660, it is perceived that the HDMI interfaces 131, 231 are mutually connected physically.

Besides the aforementioned, the HDMI interfaces 131, 231 standard is also mutually connected through a reserved line left for other purposes and a CEC (Consumer Electronic Control) line used to control a system between the TX and RX.

Referring to FIG. 5 again, the smart phone 100 which received the HPD signal perceives that the smart phone 100 and the smart pad 200 are physically connected to each other, and collects EDID (Extended Display Identification Data) from the smart pad 200 (S525). EDID is information on specifications of connected terminals, and in the exemplary embodiments of the present disclosure, EDID is information on the resolution, and includes EDID includes horizontal frequency and vertical frequency of the smart pad 200. This EDID is transmitted through the aforementioned DDC channel 650.

Thereafter, the smart phone 100 transmits the TMDS signal which is video processed or generated in the smart phone 100 based on the EDID (S530), enters into USB host mode (S540), and transmits a network setup command to the D/D (S545).

The RX determines whether or not the TMDS is received (S535), and if it is determined that the TMDS signal is received (S535-Y), the RX starts displaying regarding the received TMDS signal (S555). This displaying is processed in the RX itself, regardless of the command of the pad control unit 220 according to the result processed in the kernel area of the smart pad 200. As such, the reason why the displaying can be processed in the RX itself is because the RX is equipped with an additional transmission/reception chip for signal transmission/reception and thus is able to transmit the transmitted/received signal according to the command input from the pad control unit 220, as aforementioned. That is, the RX is able to receive video to be displayed on the smart pad 200 and start the displaying with only the signal transmission/reception with the TX.

As such, the RX is granted the maximum authority, and thus communication between the RX and the pad control unit 220 is minimized, preventing time delay and error which may occur according to the communication between the RX and the pad control unit 220.

Meanwhile, since each device of the smart pad 200 is in an inactivated state, even if the displaying has started, nothing would appear on the screen of the smart pad 200. That is, herein the fact that displaying has started merely means that video data is being received from the smart phone 100, processing such as decompressing the received data is being done, and the received data is being transmitted to display related devices, and thus, since the display related devices are not activated, the fact that displaying has started doesn't mean that the video data is being output on the screen.

As aforementioned, even though displaying has started in the inside, there is no change on the screen since the devices are inactivated, which prevents unnecessary confusion to users.

The RX transmits information regarding the state that the displaying has started to the D/D (S560).

Prior to receiving information on the state, the D/D enters the smart pad 200 to the USB client mode according to the network setup command received from the smart phone 100 (S545) which entered into the USB host mode (S555). Then, the D/D which received the information on the state requests activation on the devices to the E/C based on the information that the displaying has started (S565), and activates the devices according to the activation command received from the E/C (S570).

That is, the smart pad 200 displays the video received from the smart phone 100 in advance, and then activates the devices necessary for displaying the video, thereby preventing occurrence of the state where the devices are activated but the video signal has not yet been received.

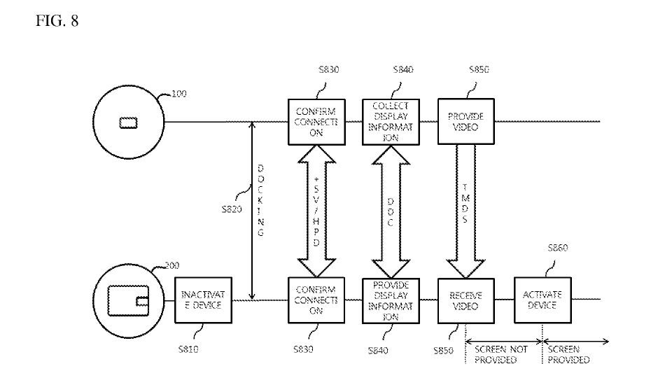

FIG. 7 is a view provided to explain the device activation according to an exemplary embodiment of the present disclosure.

In this exemplary embodiment, an LCD module, backlight module, and TSP module are used in displaying the video generated or processed in the smart phone 100.

Therefore, when the TMDS signal is transmitted to the RX, the RX starts displaying based on the received TMDS signal, and when activation is requested to the event controller 420, the event controller 420 transmits the command for activating each device to the LCD driver 710, backlight driver 720, and TSP driver 730.

FIG. 8 is a view illustrating processes from the state where a device is not activated until when it is activated, in time order.

As illustrated, the smart pad 200 maintains the inactivation state of the devices (S810). Thereafter, when the two terminals are docked on each other (S820), and it is confirmed that the terminals are mutually connected through the +5V POWER signal and the HPD signal (S830), the smart pad 100 provides and collects the EDID which is information on the displaying, through the DDC (S840).

Thereafter, video is provided and received through the TMDS data channel based on the collected EDID (S850), and each device of the smart pad 200 is activated through the process explained in FIG. 7 (S860).

As aforementioned, the important fact is that a screen is not provided to the user between the stage where video is provided and received (S850) and the stage where each device is activated (S860). That is, although displaying has started, since each device is in an inactivated state, no screen is provided to the user and the devices related to displaying do not operate either. For example, between the S850 stage and the S860 stage, there is no reaction even if the user touches the touchscreen of the smart pad 200.

As such, by starting the displaying in advance and then activating the devices, it is possible to prevent abnormal operational situations such as nothing appearing on the screen in the state where the touchscreen module and backlight module are operable, thereby achieving synchronization of activation of display devices and outputting of videos.

Hereinabove, the supposition was that a smart phone 100 and a smart pad 200 are connected to each other by an HDMI interface and USB interface, but of course it is possible to use other interfaces besides the HDMI interface and USB interface.

Not only that, it is also possible to proceed with communication for data transmission with other means instead of an HDMI interface or USB interface even when the terminals are connected by the HDMI interface and USB interface physically. For example, when two terminals are docked on each other, it means that they are quite closely located to each other, and thus it will be possible to transmit data using short distance wireless communication such as Bluetooth or WiFi.

Furthermore, a smart phone 100 and a smart pad 200 can be connected by an MHL (Mobile High-definition Link) alone instead of the HDMI interface and USB interface. An MHL (Mobile High-definition Link) is a type of interface which connects a smart phone 100 and another dummy terminal so that digital video/audio can be played, and which has an advantage that transmitting data and supplying power can be done at the same time.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A video transmitting and receiving method between docked terminals for enabling video provided from one of a first terminal and a second terminal to be displayed on the other terminal, in the case where the first terminal is docked on the second terminal through a plurality of interfaces, the method comprising:
determining whether or not the first terminal is connected to the second terminal through an HDMI interface;
receiving, by the first terminal, information on the second terminal, when it is determined that the first terminal is connected to the second terminal through the HDMI interface;
providing, by the first terminal, video to the second terminal, based on information on the second terminal; and
activating, by the second terminal, devices related to displaying of the video, when it is determined that the video is received from the first terminal.

2. The method as claimed in claim 1, the activating by the second terminal comprising:
transmitting, by the first terminal, information that video is being received from the first terminal, to a device driver of the second terminal;
transmitting, by the device driver, information to an event controller which manages events occurring when connecting the first terminal and the second controller;
transmitting, by the event controller, a command regarding activation of the devices to the device driver; and
activating, by the device driver, the devices.

3. The method as claimed in claim 1, wherein the providing, by the first terminal, video to the second terminal is characterized in that the video is provided to the second terminal in a state where devices of the second terminal are inactivated, and thus is not displayed on a screen of the second terminal.

4. The method as claimed in claim 1, wherein the devices related to displaying of the video is characterized to comprise a touchscreen panel, LCD and backlight.

5. The method as claimed in claim 1, wherein the information on the second terminal is characterized to be EDID information of the second terminal and comprises resolution, horizontal frequency, and vertical frequency information.

6. The method as claimed in claim 1, wherein the determining whether or not the first terminal is connected to the second terminal is characterized in that it is determined that the first terminal is connected to the second terminal when the first terminal transmits a signal through a +5V line of the HDMI interface and then receives the signal from the second terminal through an HPD line.

7. A docking system for enabling video received from one of a first terminal and a second terminal to be displayed on the other terminal, in the case where the first terminal is docked on the second terminal through a plurality of interfaces, the docking system comprising:
a first terminal which determines whether or not it is connected to the second terminal through an HDMI interface, receives information on the second terminal, and when it is determined that it is connected to the second terminal through the HDMI interface provides video to a second terminal based on the information on the second terminal; and
a second terminal which activates devices related to displaying of the video, when it is determined that video is received from the first terminal.
